(19) United States
(12) Patent Application Publication
(10) Pub. No.: US 2007/0072582 A1
(43) Pub. Date: Mar. 29, 2007

(54) Radio frequency scan

(75) Inventor: Mikko A. Nurmi, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/479,940

(22) Filed: Jun. 29, 2006

(30) Foreign Application Priority Data
Jun. 30, 2005 (GB) 0513266.7

(51) Int. Cl. H04M 11/04

(52) U.S. Cl. 455/404.2

(57) ABSTRACT

It is provided a method for performing a radio frequency scan in a portable electronic device. The location of the portable electronic device is determined. It is defined a search area dependent on the location of the portable electronic device. The portable electronic device receives radio signals from a plurality of other electronic devices to determine the identities of the other electronic devices, the identities of the other electronic devices defining a first group of identified electronic devices. The respective locations of the plurality of other electronic devices are determined. The location of each of the plurality of other electronic devices are compared with the defined search area to create a second group of identified electronic devices, wherein the second group is a subset of the first group.

### CROSS REFERENCE TO RELATED APPLICATIONS

This application claims priority under 35 USC §119 to United Kingdom Patent Application No. 0513266.7 filed on Jun. 30, 2005.

### FIELD OF THE INVENTION

The invention relates to a method for performing a radio frequency scan in a portable electronic device. The invention also relates to a corresponding portable electronic device, system, module, software code and software program product.

### BACKGROUND OF THE INVENTION

A wireless personal area network (PAN) may consist of multiple devices that can communicate with each other. Bluetooth is an example of an industrial specification for wireless PANs.

Bluetooth provides a way to connect and exchange information between devices like personal digital assistants (PDAs), mobile phones, laptops, PCs, printers, headsets, and digital cameras via a secure, globally available short range circuit.

Bluetooth enables devices to communicate with each other when they come in range, even if they are not in the same room, as long as they are within 10 meters (32 feet) of each other. Some specifications allow communications up to 100 meters (such as Class 1 devices) if environmental conditions are optimal. Currently the latest version available for consumers is 2.0.

A bluetooth device acting as a master can communicate up to 7 devices called slaves. At any time instant, data can be transferred between the master and one slave and master switching rapidly from slave to slave. Simultaneous transmission from the master to multiple slaves is possible although this is not used much in practise. Groups of up to 8 devices (1 master and 7 slaves) are called piconets.

Bluetooth connection can be set up by performing a search or a scan. When performing the scan, the scanning device searches for other active Bluetooth devices. When the scan is completed the search result is shown to the user of the scanning device.

Currently the number of Bluetooth capable devices is increasing and if the user of the scanning device happens to be in a place, such as a sports arena, where there are lots of active Bluetooth devices, the search list can be very long and it can take a long time before the search is completed. Users of the Bluetooth devices have often named their devices rather unclearly and thus it may be difficult for the user of the scanning device to pick up the right device from the search list to start a communication session, especially if there are lots of devices on the search list. Furthermore, in the future the range of Bluetooth or other PAN connections may increase, and this makes it even more difficult to find a certain searched device.

### SUMMARY OF THE INVENTION

The applicant has recognised that there is a need for an improved radio frequency scan. Only devices detected in a certain area should be visible to the user initialising the scan.

According to a first aspect of the invention there is provided a method for performing a radio frequency scan in a first portable electronic device, the method comprising determining the location of the first portable electronic device, defining a search area dependent on the location of the first portable electronic device, receiving radio signals from a plurality of other electronic devices to determine the identities of the other electronic devices, the identities of the other electronic devices defining a first group of identified electronic devices, determining the respective locations of the plurality of other electronic devices, and comparing the location of each of the plurality of other electronic devices with the defined search area to create a second group of identified electronic devices, wherein the second group is a subset of the first group.

A method in accordance with the invention has the advantage that only devices that are detected in the search area are listed to the user of the portable electronic device. Thus it is easier and quicker for the user of the portable electronic device to start a communication session with another electronic device.

The method may further comprise that the search area is directional.

The method may further comprise that the direction of the search area depends on the direction to which the first portable electronic device is moving.

The method may further comprise that the direction of the search area depends on the path along which the first portable electronic device is moving.

The method may further comprise that the radio frequency scan is a Bluetooth scan.

The method may further comprise the first portable electronic device initialising the radio frequency scan.

The method may further comprise interrogating the other electronic devices to determine their location.

According to a second aspect of the invention there is provided a module for performing a radio frequency scan in a first portable electronic device, the module comprising means for determining the location of the first portable electronic device, means for defining a search area dependent on the location of the first portable electronic device, means for receiving radio signals from a plurality of other electronic devices to determine the identities of the other electronic devices, the identities of the other electronic devices defining a first group of identified electronic devices, means for receiving the respective locations of the plurality of other electronic devices, and means for comparing the location of each of the plurality of other electronic devices with the defined search area to create a second group of identified electronic devices, wherein the second group is a subset of the first group.

According to a third aspect of the invention there is provided a portable electronic device comprising the module in accordance with the second aspect of the invention.

According to a fourth aspect of the invention there is provided a system comprising a portable electronic device according to the third aspect of the invention and at least one other electronic device knowing its location and having communications capabilities.

According to a fifth aspect of the invention there is provided a software code implementing the method steps according to the first aspect of the invention.

According to a sixth aspect of the invention there is provided a computer program product in which the software code according to the fifth aspect of the invention is stored and executed by a processor to implement the method according to the first aspect of the invention.

According to a seventh aspect of the invention there is provided a method for a first electronic device to perform a radio frequency scan, the method comprising defining a search area, determining the location of the first portable electronic device, determining the location of at least one other electronic device, when detected devices are not in said search area, they are filtered out from the search result and the number of devices provided by the search result being smaller than the number of detected devices.

### BRIEF DESCRIPTION OF THE FIGURES

Other features of the present invention will become apparent from the following detailed description when considered in conjunction with the accompanying drawings, in which:

FIG. 1 illustrates an environment in which a portable electronic device can search for other electronic devices.

FIG. 2 is a flow chart illustrating a method according to an embodiment of the invention.

FIG. 3 is a block diagram illustrating a wireless terminal comprising Bluetooth transmission capabilities according to an embodiment of the invention.

### DETAILED DESCRIPTION OF EMBODIMENTS OF THE INVENTION

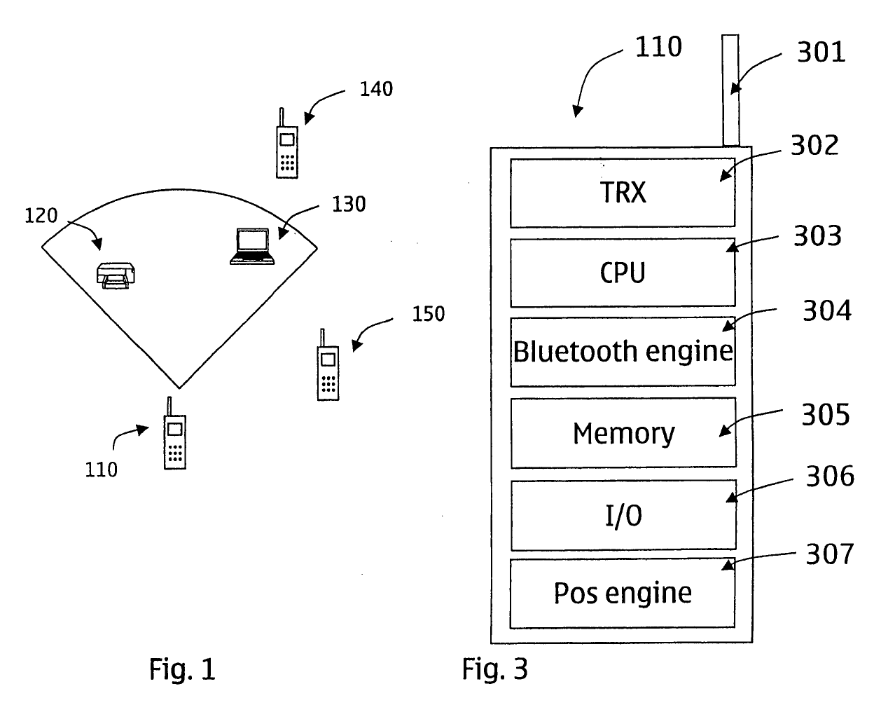

FIG. 1 illustrates an operational environment in which embodiments of the present invention may exist. Specifically, in FIG. 1, there is shown a portable electronic device 110, in this case a mobile phone handset, which includes Bluetooth communication capabilities. The electronic device 110 could also be for instance a PDA, laptop, PC, printer, or digital camera or any other electronic device having communication capabilities that require a scan or search of other electronic devices to be done before a communication session can commence.

FIG. 1 also shows other electronic devices 120, 130, 140 and 150. In this particular example the electronic devices 120 and 130 represent a printer and a laptop computer, respectively. The electronic devices 140 and 150 are other mobile phone handsets. One common factor for all of these devices is that they include communication capabilities and in order to initialise the communication session, a scan or search is required. These devices could also be any electronic devices having such communication capabilities, such as Bluetooth.

The mobile phone handset 110 uses a Bluetooth technique in order to transmit electromagnetic signals and communicate with other electronic devices. Also a type of communication technique other than Bluetooth can be used as long as a search procedure is required before the communication between the electronic devices can commence.

The handset 110 performs a scan within a certain range in order to find other active Bluetooth devices in order to start the communication session. In FIG. 1 it can be seen that only devices 120 and 130 are within the predefined range.

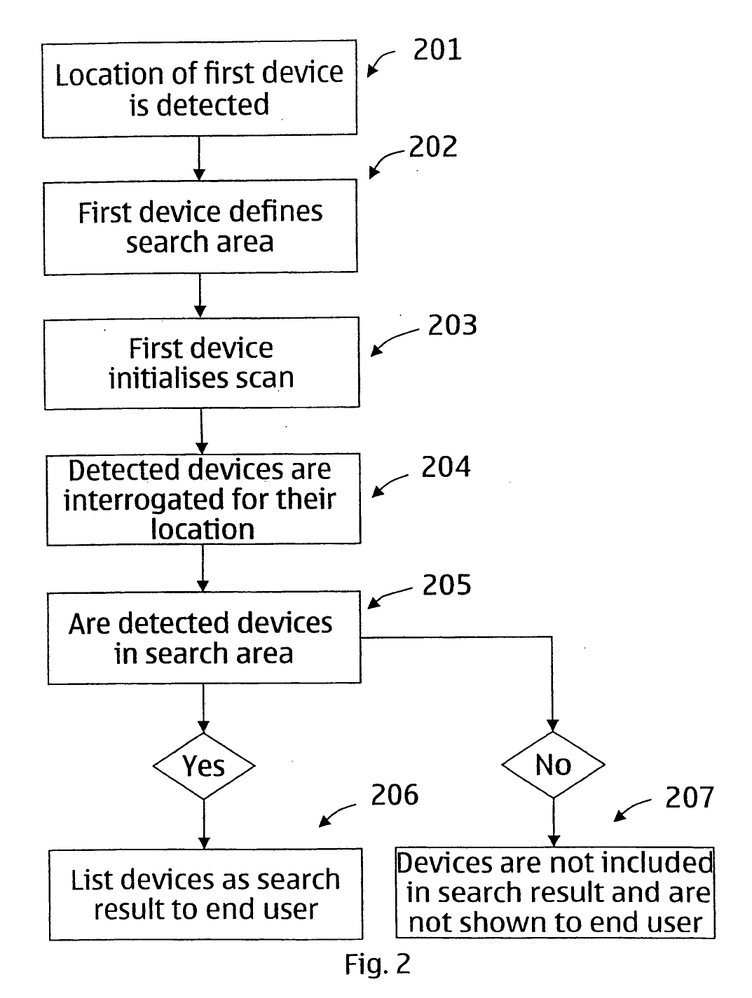

FIG. 2 illustrates a method for filtering the search results when for instance a Bluetooth search or scan is performed. At step 201 the location of the first electronic device, in this case the handset 110, is detected. At step 202, the user of the handset 110 defines the search area in which they believe the other electronic device is located with which they want to start a communication session. The user of the handset 110 wants to commence a communication session with at least one of the devices detected in the search area. At step 203, the handset 110 initialises a scan in order to detect other active Bluetooth devices. At step 204, all detected devices are interrogated for their location. At step 205, the handset 110 determines whether the detected devices are in the search area defined by the user of the handset 110. At step 206, all devices that are in the predefined search area are listed as a search result to the user of the handset 110. If the detected devices are not in the search area, then these devices are ignored and they are not shown to the user of the handset 110 (step 207).

FIG. 3 is a block diagram of the mobile phone handset 110 of FIG. 1. The handset 110 functions as a cellular telephone according to, for example, one or many of the following standards: GSM, GPRS, EDGE, HSCSD, UMTS, CDMA 2000, IS95, etc. The handset 110 also comprises a memory 305. The memory may have random access (RAM) and read only memory (ROM) parts. Suitable data can be stored in that memory. Furthermore, handset 110 contains input/output (I/O) means 306. Input means may be for instance a keyboard but it can also be a touch pad or a touch screen. A microphone may also be provided as an input means for receiving voice information. Output means may be provided for instance by a display, such as a liquid crystal display (LCD). A loudspeaker may also be provided as an output means for outputting speech or sound. Other suitable input/output means are also possible.

The handset 110 also includes a Bluetooth engine 304 for providing Bluetooth communication capabilities. The handset also includes transceiver unit 302 (TRX). For receiving and transmitting signals, the handset 110 includes an antenna 301. Two or more separate antennas could also be used, but in this embodiment the same antenna can receive and transmit signals of Bluetooth, cellular and positioning systems.

The handset 110 also includes a central processing unit 303 (CPU) for centrally controlling the functioning of the handset 110. The CPU includes one or more processing units depending on the implementation of the handset 110.

The operation of the handset 110 of FIG. 3 will now be described in more detail with reference to the flow chart of FIG. 2. At step 201, the geographical location of the handset is detected. The geographical location of the handset can be detected either by the handset 110 itself or by some other network element, such a base station of a cellular communication system. The handset 110 can detect its location by using, for instance, the positioning engine 307. Examples of such engines are global positioning system (GPS), European alternative Galileo or Russian GLONASS. Using satellite positioning system requires that the handset 110 has got sufficient means for performing satellite positioning. Using satellite positioning would make it possible to achieve accuracy of better than 10 metres. In order to improve accuracy of standard satellite positioning there are several possibilities currently available, such as differential GPS (DGPS), wide area augmentation system (WAAS), wide area GPS enhancement (WAGE), relative kinematic positioning (RKP) or real-time kinematic positioning (RTK). For instance RKP provides accuracy less than 10 centimetres. Furthermore, some WLAN based location detection means may be used, as well any other suitable means for detecting accurate location.

If the location of the handset 110 is detected by the network, the location information may need to be sent to the handset 110 so that also the handset 110 knows its location. Base stations of the cellular communication systems can determine locations of mobile phones by detecting the current cell identity. This is possible because each cell in a cellular system has got a unique code, known as cell ID, which is used to identify the current cell. Better accuracy is achieved the smaller the cell size is.

At step 202, the user of the handset 110 defines a search area. The user of the handset 110 would like to start a communication session with at least one other device located in that area. Thus the user of the handset 110 is not interested in other devices detected outside this area. Only devices that are found in that predefined search area are shown to the user of the handset 110. This is advantageous, since now the user of the handset 110 does not have to go through long list of devices but instead only one or very few devices are now visible to the user of the handset 110. Now the user of the handset 110 can easily choose with whom to start a communication session using for instance Bluetooth connectivity method. The user of the handset 110 can define the search area, for instance, by pointing their device to a certain direction and then defining a sector from where they want to list active Bluetooth devices. Thus it may be necessary for the user of the handset 110 to define an angular or directional range and a distance within which they want to list all active Bluetooth devices. Furthermore, it may be necessary for the searching device, in this case handset 110, to know also its direction, especially if the search area is defined by pointing the handset 110 to a certain direction.

Referring to FIG. 1, it can be seen that the user of the handset 110 has defined a search area, which in this case is a sector pointing away from the handset 110. The user of the handset knows that the devices with which they want to start a communication session are in front of them within a certain distance. As a search result they would get only devices 120 and 130, whereas devices 140 and 150 would not be visible to them. The search area can be of any shape defined by the user of the handset 110.

At step 203, handset 110 initialises search. Handset 110 searches for all devices it is able to detect. When a new active device is detected, at step 204 the handset 110 interrogates for their current location. This also requires that the searched devices know their location. The searched devices can use the same methods as the handset 110 to find their locations. The location information can be sent to the handset 110, for instance, over Bluetooth connection or by using any other suitable communication method.

Alternatively, if the searched device is not mobile or is moving rarely, such as a printer, it is not necessary to determine its location continuously. Instead, these kind of devices could have predefined location coordinates and these coordinates could be given to the handset 110 when interrogated and handset 110 could store the coordinates in its memory 305. Thus it would not be necessary for these kind of devices to define their location by themselves.

When the handset 110 knows the location of the devices it has detected, then at step 205 the handset 110 decides whether the detected devices are in the predefined search area or not.

If the detected devices are in the predefined search area, then at step 206 these devices are shown to the user of the handset 110 as a search result. Furthermore, the devices that are in the predefined search area could be showed to the user of the handset in a certain order, for instance, the device which is closest to the handset 110 is the first result on the search list whereas the device which is the most distant is the last on the search list. It would also be possible to show graphically the locations of the search devices on the search list. Also only distance to the handset 110 could be shown.

However, if the detected devices are not in the predefined search area, then these devices are neglected and they are not shown to the user of the handset 110.

If the searched device is a device which is not moving constantly, for instance a printer, then the coordinates of this device could be saved in the memory of the handset 110. Thus after the user of the handset 110 has defined the search area and if the printer is in this area, it could be shown to the user of the handset 110 before the search is initiated.

According to a second embodiment of the invention the handset 110 could use directional antennas to search for devices only from a certain area. According to the second embodiment, it would not be necessary for the electronic devices to detect their location. In this case all detected devices are automatically shown to the user of the handset 110.

The present invention has many useful usage areas. The present invention is especially useful in a place where there are lots of people with active Bluetooth devices. Another interesting field of application would be a situation in which the user of the handset 110 moves in a certain direction. In this case the user might only be interested in oncoming active Bluetooth devices. Thus the user of the handset 110 could define the search area to be in front of the user. Also if the user of the handset 110 moves on a certain path, then the search area could depend on this path.

The invention also relates to a corresponding computer program product including software code, which can be used to implement at least some parts of the method according to the embodiments described above. The invention equally relates to a corresponding software program product in which a software code can be stored.

In the handset 110 all inventive features could be incorporated into a single module. According to the first embodiment, the module includes at least a processor for implementing the described method steps. The module does not necessarily have to find the location itself, but instead it could control the procedure of finding the location.

The invention also relates to the handset 110, which comprises means for implementing the methods described above. According to the first embodiment, the handset 110 also comprises the module described above.

Finally the invention relates to a system in which the handset 110 can be used. The system comprises at least the handset 110 and at least one searched device.

It is to be noted that the described embodiments can be varied in many ways and that these are just exemplary embodiments of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising;
determining the location of a first portable electronic device,
defining a search area dependent on the location of the first portable electronic device,
receiving radio signals from a plurality of other electronic devices to determine the identities of the other electronic devices, the identities of the other electronic devices defining a first group of identified electronic devices,
determining the respective locations of the plurality of other electronic devices, and
comparing the location of each of the plurality of other electronic devices with the defined search area to create a second group of identified electronic devices, wherein the second group is a subset of the first group.

2. The method according to claim 1, wherein the first portable electronic device is a mobile phone handset.

3. The method according to claim 1, wherein the method comprises the user of the first portable electronic device defining the search area.

4. The method according to claim 1, wherein the search area is directional.

5. The method according to claim 1, wherein the direction of the search area depends on the direction to which the first portable electronic device is moving.

6. The method according to claim 1, wherein the direction of the search area depends on the path along which the first portable electronic device is moving.

7. The method according to claim 1, wherein the radio frequency scan is a Bluetooth scan.

8. The method according to claim 1, wherein the method comprises the first portable electronic device initialising the radio frequency scan.

9. The method according to claim 1, wherein the method comprises interrogating the other electronic devices to determine their location.

10. The method according to claim 9, wherein the method comprises the interrogated electronic devices transferring their location information to the first portable electronic device.

11. The method according to claim 1, wherein the method comprises the electronic devices of the second group listing as a search result for the user of the first portable electronic device.

12. The method according to claim 1, wherein the method comprises determining the locations of the first portable electronic device and/or the other electronic devices are determined by satellite positioning.

13. The method according to claim 1, wherein the method comprises storing the location of at least one electronic device of the second group in the memory of the first portable electronic device.

14. The method according to claim 1, wherein the first portable electronic device knows its direction.

15. A module comprising:
a positioning engine for determining the location of the first portable electronic device,
a processing unit configured for defining a search area dependent on the location of the first portable electronic device,
a receiver for receiving radio signals from a plurality of other electronic devices to determine the identities of the other electronic devices, the identities of the other electronic devices defining a first group of identified electronic devices,
wherein the processing unit is further configured for receiving the respective locations of the plurality of other electronic devices, and for comparing the location of each of the plurality of other electronic devices with the defined search area to create a second group of identified electronic devices, wherein the second group is a subset of the first group.

16. The module according to claim 15, comprising a memory for storing the location of at least one other electronic device in its memory.

17. The module according to claim 15, wherein the processing unit is configured for initialising the radio frequency scan.

18. The module according to claim 15, wherein the processing unit is further configured for inquiring the location of the other electronic devices.

19. The module according to claim 15, wherein the first portable electronic device is a mobile phone handset.

20. A portable electronic device comprising the module according to claim 15.

21. The portable electronic device according to claim 20, wherein the portable electronic device is a mobile phone handset.

22. A system comprising a portable electronic device according to claim 20 and at least one other electronic device knowing its location and having communications capabilities.

23. A computer program product having a readable medium in which the software code is stored in a readable medium for implementing the method of claim 1.

24. A method for a first electronic device to perform a radio frequency scan, the method comprising;
defining a search area,
determining the location of the first portable electronic device,
determining the location of at least one other electronic device,
when detected devices are not in said search area, they are filtered out from the search result and the number of devices provided by the search result being smaller than the number of detected devices.

25. A module comprising;
means for determining the location of the first portable electronic device,
means for defining a search area dependent on the location of the first portable electronic device,
means for receiving radio signals from a plurality of other electronic devices to determine the identities of the other electronic devices, the identities of the other electronic devices defining a first group of identified electronic devices,
means for receiving the respective locations of the plurality of other electronic devices, and
means for comparing the location of each of the plurality of other electronic devices with the defined search area to create a second group of identified electronic devices, wherein the second group is a subset of the first group.

26. The module according to claim 25, comprising means for storing the location of at least one other electronic device in its memory.

27. The module according to claim 25, comprising means for initialising the radio frequency scan.

28. The module according to claim 25, further comprising means for inquiring the location of the other electronic devices.
